(19) United States
(12) Patent Application Publication
(10) Pub. No.: US 2026/0203244 A1
(43) Pub. Date: Jul. 16, 2026

(54) Data acquisition system

(71) Applicant: SICK AG, Waldkirch (DE)

(72) Inventor: Jan MAHLER, Pfaffenweiler (DE)

(21) Appl. No.: 19/444,589

(22) Filed: Jan. 9, 2026

(30) Foreign Application Priority Data
Jan. 10, 2025 (DE) 102025100748.9

(51) Int. Cl. G06F 13/42; G06F 13/38

(52) U.S. Cl. CPC G06F 13/4282; G06F 13/382; G06F 2213/0042

(57) ABSTRACT

A data acquisition system comprises at least one sensor device comprising a detection unit, at least one sensor communication interface and a sensor control unit, wherein the sensor device is configured to acquire first object data using the detection unit, and at least one USB-HID adapter device that is configured to provide a communication connection between the sensor device and an external control device, wherein the USB-HID adapter device comprises a first adapter communication interface, a second adapter communication interface and an adapter control unit, wherein the sensor control unit is configured to obtain configuration information, to generate a control command based on the configuration information and to transmit the first object data and the control command via the at least one sensor communication interface to the USB-HID adapter device.

The invention relates to a data acquisition system, a USB-HID adapter device for a data acquisition system, a sensor device for a data acquisition system, and a method for acquiring object data using a data acquisition system.

Conventional data acquisition systems are, for example, used in industrial environments such as production plants or logistics distribution centers and usually serve to acquire information from objects or products and to transmit said information to a higher-level control device or processing apparatus. The acquired information or data are, for example, used to characterize and/or to classify objects.

Such data acquisition systems usually have a sensor for acquiring object data that is connected to the customer-side processing apparatus for exchanging data. However, advanced sensors, in particular their connection type or their type of data transmission, are not compatible with the customer application in many cases.

It is the object of the invention to provide a more versatile data acquisition system.

The aforesaid object is satisfied by a data acquisition system according to claim 1.

The data acquisition system comprises at least one sensor device and at least one Universal Serial Bus-Human Interface Device (USB-HID) adapter device. The data acquisition system in particular comprises exactly one sensor device and/or exactly one USB-HID adapter device. Depending on the application, the data acquisition system can, however, also comprise two or more sensor devices and/or two or more USB-HID adapter devices.

The USB Human Interface Device Class (USB HID Class) is part of the USB specification for computer peripheral devices. It specifies a device class (i.e. a type of computer hardware) for human interface devices such as keyboards, mice, touchscreens and alphanumeric display devices. The USB HID keyboard, for example, usually has an IN endpoint that transmits the keystrokes to the computer and an OUT endpoint that transmits the status of the keyboard LEDs from the computer to the keyboard. USB HID mice can range from simple devices with one button to composite devices with multiple buttons. Most modern operating systems are supplied with drivers for standard HID mouse designs.

The data acquisition system can be configured to classify objects. The data acquisition system, in particular the sensor control unit, can in particular be configured to determine a property of the object and/or an object type. The property indicates, for example, whether the object is free of defects or has a (manufacturing) defect. However, the property can also specify a price and/or a sender address and/or receiver address of the object. The object is, for example, an industrially manufactured product and/or a product to be industrially manufactured, freight such as a parcel or a letter, and/or consumer goods.

The sensor device comprises a detection unit, at least one sensor communication interface and a sensor control unit.

The sensor control unit can have a CPU and/or a memory unit that is/are preferably arranged on a circuit board. The circuit board can be arranged in a housing of the sensor device.

The detection unit can be an optical detection unit. For example, the detection unit comprises a transmission optics and/or reception optics, e.g. in the form of a lens, a light source for transmitting measurement light and/or a detector for detecting measurement light reflected or remitted by an object. The light source can e.g. be an area illumination or a linearly projected laser beam.

The sensor device is configured to acquire first object data via the detection unit. The sensor device is in particular configured to obtain and evaluate optical object data from the detection unit in order to acquire the first object data.

The USB-HID adapter device is configured to provide a communication connection between the sensor device and an external control device. In other words, when in use, the sensor device and the external control device can exchange data via the USB-HID adapter device.

The external control device is, for example, a server, preferably for controlling an industrial process, a laptop, a PC and/or a tablet. The external control device can comprise a human-machine interface, in particular a keyboard, a touch pad, a mouse and/or an automatic voice recognition for receiving a user input.

The USB-HID adapter device comprises a first adapter communication interface, a second adapter communication interface and an adapter control unit.

The adapter control unit can have a CPU and/or a memory unit that are preferably arranged on a circuit board. The circuit board can be arranged in a housing of the USB-HID adapter device.

The first adapter communication interface and the second adapter communication interface can differ from one another, in particular in their connection type and/or their type of data transmission. However, they can also be interfaces of the same type.

The sensor control unit is configured to obtain configuration information, to generate a control command based on the configuration information and to transmit the first object data and the control command via the at least one sensor communication interface to the USB-HID adapter device.

The adapter control unit is configured to obtain the first object data and the control command via the first adapter communication interface, to convert the first object data into second object data different from the first object data based on the control command, and to transmit at least the second object data to the external control device via the second adapter communication interface.

In other words, the adapter device of the system is not configured directly, but rather indirectly by configuring the sensor device so that the object data or sensor data can be transmitted to the external control device, in particular in the correct format. This means that, by providing the control command, the sensor device ultimately sets the manner in which the adapter device transmits the object data.

This approach offers several advantages. On the one hand, the sensor device can be adapted to the respective application situation as required in a simple and user-friendly manner by receiving the configuration information, i.e. via software settings that can be made in a comfortable manner. In particular, no different hardware variants of the sensor device are required. In addition, since the adapter device can be configured by the sensor device, a different adapter is not required for each sensor of a complex sensor portfolio, which significantly reduces the complexity of the system. Therefore, the data acquisition system according to the invention is inter alia characterized by an increased user-friendliness, versatility and cost-effectiveness.

Possible further developments of the invention are specified in the dependent claims, in the drawing and in the following description.

According to one embodiment, the control command specifies a keyboard layout of the external control device. In particular, the keyboard layout is specific to a geographical region. The control command in particular comprises one or more of the following control characters: DE (for German), US (for United States of America), UK (for United Kingdom), FR (for French).

According to one embodiment, the second object data from the USB-HID adapter device are adapted to the keyboard layout of the external control device. This means that the USB-HID adapter device automatically sends the sensor data in the correct layout format.

According to one embodiment, the sensor control unit is configured to obtain the configuration information from the external control device via the at least one sensor communication interface, in particular in response to a selection of the keyboard layout by a user in a web user interface (web UI). This is particularly user-friendly.

The web UI can, for example, be accessed by the user entering an IP address specified on the sensor device into a web browser. The user can, for example, access the web UI via the external control device. As a result, no admin rights of the user are required to configure the adapter.

The sensor device can be configured to provide the web UI. In particular, the sensor device can comprise a web server on which the web UI is stored.

According to one embodiment, the sensor control unit is configured to obtain the configuration information by scanning a (specific) barcode using the detection unit. The barcode can be arranged on an object to be classified or can be arranged on the identification card mentioned below or the like. The (specific) barcode can contain a configuration code, e.g. a specific character string that is not normally used and that is recognized by the sensor control unit and processed as configuration information. This means that the selection of the keyboard layout takes place automatically on the basis of the information contained in the barcode. As a result, no (manual) user selection is required.

According to one embodiment, the sensor control unit is configured to obtain the configuration information by acquiring user-specific information using the detection unit. The acquisition of the user-specific information can comprise scanning an identification card of the user. This means that the selection of the keyboard layout takes place automatically based on a recognition of the current user, which is particularly simple and user-friendly.

The aforementioned procedures for obtaining the configuration information can each take place individually or can be combined as required.

According to one embodiment, the sensor device comprises a first sensor communication interface and a second sensor communication interface that differ from one another, in particular with respect to their connection type and/or their type of data transmission. More than two sensor communication interfaces of different types can also be provided.

The at least one sensor communication interface, in particular the first sensor communication interface, and/or the second adapter communication interface can comprise a USB port.

Additionally or alternatively, the at least one sensor communication interface, in particular the second sensor communication interface, and/or the first adapter communication interface comprises/comprise an Ethernet port.

The sensor control unit can be configured to obtain the configuration information from the external control device via the first sensor communication interface and to transmit the first object data and the control command via the second sensor communication interface to the USB-HID adapter device. In particular, the sensor device can preferably be configured via USB and preferably communicates via Ethernet with the USB-HID adapter device.

According to one embodiment, the sensor device comprises a field bus for the data exchange with the external control device and/or the USB-HID adapter device.

According to one embodiment, the sensor control unit is configured to transmit the first object data and the control command in a first data string. The first data string can also contain further data that are preferably arranged at the start and/or end of the first data string. The adapter control unit is configured to filter out the control command from the first data string.

The adapter control unit can be configured to remove the control command from the first data string and to replace the first object data with the second object data in the first data string in order to generate a second data string, and to transmit the second data string to the external control device via the second adapter communication interface. This reduces the volume of transmitted data.

According to one embodiment, the first and/or second object data comprise barcode information and/or image information of an object to be classified. This means that the sensor device can be a barcode reader for detecting a barcode that is preferably arranged on an object. In general, the sensor device can be configured to recognize machine-readable codes, e.g. QR codes, barcodes, postal codes and the like. The recognized machine-readable code can in particular be output or transmitted as part of the first object data via the sensor communication interface. The sensor device can comprise a camera device for acquiring image information of an object.

The invention furthermore relates to a USB-HID adapter device for a data acquisition system, in particular according to at least one of the preceding embodiments. The USB-HID adapter device comprises a first adapter communication interface, a second adapter communication interface and an adapter control unit. The USB-HID adapter device is configured to provide a communication connection between a sensor device for acquiring first object data and an external control device. The adapter control unit is configured to obtain the first object data and a control command from the sensor device via the first adapter communication interface, to convert the first object data into modified second object data based on the control command, and to transmit at least the second object data to the external control device via the second adapter communication interface.

The USB-HID adapter device according to the invention can be automatically adapted to the respective application by obtaining the control command and thus enables a smooth and correct data exchange between the sensor device and the external control device.

The invention further relates to a sensor device for a data acquisition system, in particular according to at least one of the preceding embodiments. The sensor device comprises a detection unit, preferably an optical detection unit, at least one sensor communication interface and a sensor control unit. The sensor device is configured to acquire first object data via the detection unit. The sensor control unit is configured to obtain configuration information, to generate a control command based on the configuration information and to transmit the first object data and the control command via the at least one sensor communication interface to a USB-HID adapter device that is configured to provide a communication connection between the sensor device and the external control device.

The sensor device according to the invention can be configured in a particularly simple and user-friendly manner by obtaining the configuration information. It is furthermore able to automatically set the USB-HID adapter device to the respective application by transmitting the control command.

The invention also relates to a method for acquiring object data using a data acquisition system, in particular according to at least one of the preceding embodiments. The data acquisition system comprises at least one sensor device comprising a detection unit, preferably an optical detection unit, at least one sensor communication interface and a sensor control unit, wherein the sensor device is configured to acquire first object data via the detection unit. The data acquisition system further comprises at least one Universal Serial Bus-Human Interface Device (USB-HID) adapter device that is configured to provide a communication connection between the sensor device and an external control device. The USB-HID adapter device comprises a first adapter communication interface, a second adapter communication interface and an adapter control unit. The method comprises obtaining configuration information by means of the sensor control unit; generating a control command based on the configuration information by means of the sensor control unit; transmitting, by means of the sensor control unit, the first object data and the control command via the at least one sensor communication interface to the USB-HID adapter device; obtaining, by means of the adapter control unit, the first object data and the control command via the first adapter communication interface; converting, by means of the adapter control unit, the first object data into modified second object data based on the control command; and transmitting, by means of the adapter control unit, at least the second object data to the external control device via the second adapter communication interface.

The method according to the invention for acquiring object data is particularly user-friendly and efficient.

The features and advantages described with respect to the embodiments of the data acquisition system can be transferred to the USB-HID adapter device, the sensor device and the method for acquiring object data.

The invention will be described in the following by way of example with reference to the drawing. There are shown:

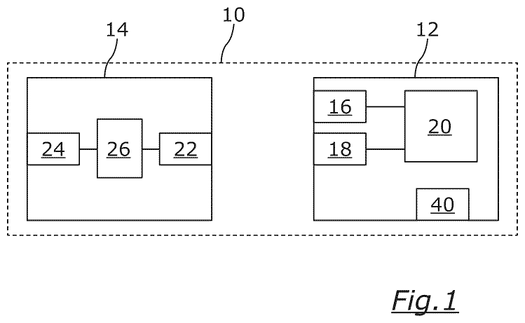

FIG. 1 a simplified block diagram of a data acquisition system; and

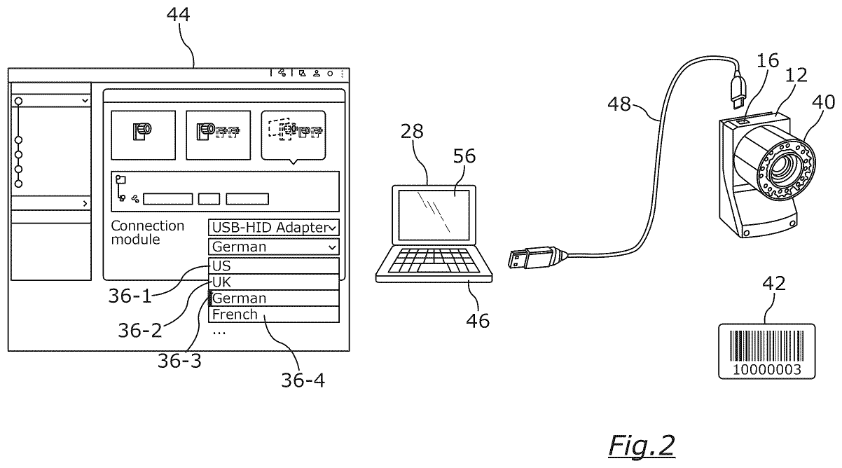

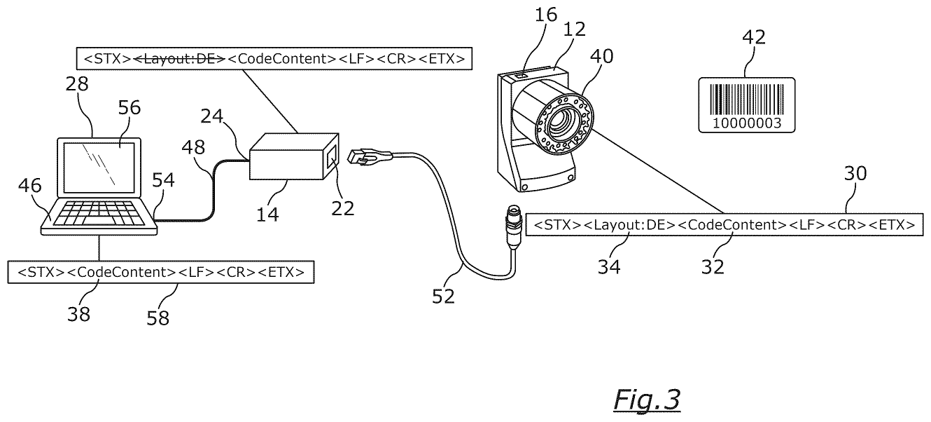

FIGS. 2 and 3 a simplified representation of a method for acquiring object data.

FIG. 1 shows a block diagram of a data acquisition system 10 that comprises a sensor device 12 and a USB-HID adapter device 14. The sensor device 12 and the USB-HID adapter device 14 are arranged structurally separately from one another, i.e. they each have a separate housing (see FIG. 3). Exactly one or two or more sensor devices 12 can be provided. The same applies to the USB-HID adapter device 14. The data acquisition system 10 is configured to classify objects.

The sensor device 12 has an optical detection unit 40 for acquiring object data 32, a USB port or a first sensor communication interface 16 for exchanging data with an external control device 28 (see FIGS. 2 and 3), an Ethernet port or a second sensor communication interface 18 for exchanging data with the USB-HID adapter device 14, and a sensor control unit 20 for controlling the operation of the sensor device 12. However, only a single port can also be provided for communicating with the external control device 28 and the USB-HID adapter device 14. Depending on requirements, more than two communication interfaces are provided.

The USB-HID adapter device 14 comprises an Ethernet port or a first adapter communication interface 22 for exchanging data with the sensor device 12, a USB port or a second adapter communication interface 24 for exchanging data with the external control device 28, and an adapter control unit 26 for controlling the operation of the USB-HID adapter device 14. Depending on requirements, three or more communication interfaces can also be provided.

As shown in FIG. 2, in order to configure the sensor device 12, the external control device 28, which is shown here by way of example as a laptop with a screen 56 and a keyboard 46, is first connected to the sensor device 12 via a USB cable 48. However, a wireless communication connection or an Ethernet connection can also be established, for example. Instead of a laptop, it can also be a desktop PC or a server or the like (not shown).

Furthermore, the sensor device 12 is described here by way of example as an advanced sensor comprising an optical detection unit 40 that has a light source, a lens arrangement and a detector for acquiring object data. The sensor device 12 is, for example, configured to detect a barcode 42, i.e. it can be designed as a barcode reader. The sensor device 12 can additionally or alternatively be adapted to recognize defects or deviations in products, preferably automatically, for example in an AI-based manner.

After establishing the USB connection 48 between the laptop and the sensor device 12, a user accesses a web UI 44 via the laptop and there selects the correct layout 36 of the keyboard 46 of the laptop from a plurality of optional keyboard layouts 36-1 to 36-4.

Preferably, the web UI 44 is automatically displayed when the USB connection 48 is established. This means that the web UI 44 can be stored in the sensor device 12 and can be provided by it, as required.

In response to the user selection, corresponding configuration information is transmitted from the laptop to the sensor device 12 that stores the configuration information. In the example shown, the configuration information indicates that the keyboard 46 has a German keyboard layout 36 (“German”). Thus, the configuration of the sensor device 12 is concluded.

In addition or as an alternative to the described procedure, the sensor device 12 can be configured by scanning the barcode 42. In this respect, the sensor device 12 automatically extracts the configuration information from the (image) information contained in the barcode 42.

A further embodiment provides that the sensor device 12 can be conveniently configured by scanning an identification card (not shown) of a user. In this respect, the sensor device 12 acquires image data of the identification card, for example a barcode on the card, and extracts the configuration information from the information contained in the image data.

The methods mentioned for obtaining the configuration information are particularly simple and user-friendly and can be combined as required or can be executed individually in each case.

As shown by way of example in FIG. 3, the sensor device 12 is first connected to the external control device 28 via the USB-HID adapter device 14 in order to acquire object data. In this respect, the Ethernet port 18 of the sensor device 12 is connected to the Ethernet port 22 of the USB-HID adapter device 14 via an Ethernet cable 52 and the USB port 24 of the USB-HID adapter device 14 is connected to a USB port 54 of the external control device 28 via a USB cable 48.

The sensor device 12 then acquires first object data 32 by means of the optical detection unit 40. In the example shown, the sensor device 12 scans a barcode 42 that is arranged on an object to be classified (not shown). This means that the first object data 32 here are barcode information that, for example, specifies the properties of the object.

Furthermore, the sensor control unit 20 of the sensor device 12 generates a control command 34 for the USB-HID adapter device 14 from the previously obtained configuration information. Consequently, the control command 34 in the example shown indicates that the keyboard layout 36 of the external control device 28 is German.

The sensor control unit 20 then generates a first data string 30, which inter alia contains the first object data 32 (“<CodeContent>”) and the control command 34 (“<Layout: DE>”), and transmits the first data string 30 via the Ethernet connection 52 to the adapter control unit 26 of the USB-HID adapter device 14.

The adapter control unit 26 then extracts the control command 34 and converts the first object data 32 into second object data 38 based on the control command 34. The first object data 32 differ from the second object data 38 in that the second object data 38 are present in the correct or previously selected keyboard layout 36.

Subsequently, the adapter control unit 26 generates a second data string 58 by replacing the first object data 32 with the second object data 38 in the first data string 30 and deleting or removing the control command 34 from the first data string 30.

The second data string 58 is then transmitted to the external control device 28 via the USB connection 48.

Consequently, the barcode 42 scanned by the sensor device 12 is automatically displayed in the correct manner as a sequence of letters and/or numbers on the screen 56 of the external control device 28.

The procedure for acquiring object data described with reference to FIGS. 2 and 3 is particularly user-friendly and efficient. The data acquisition system 10 used in this respect is characterized by a reduced complexity and an increased cost-effectiveness.

### REFERENCE NUMERAL LIST

10 data acquisition system
12 sensor device
14 USB-HID adapter device
16 first sensor communication interface
18 second sensor communication interface
20 sensor control unit
22 first adapter communication interface
24 second adapter communication interface
26 adapter control unit
28 external control device
30 first data string
32 first object data
34 control command
36 keyboard layout
38 second object data
40 detection unit
42 barcode
44 web UI
46 keyboard
48 USB cable
52 Ethernet cable
54 USB port of the external control device
56 screen of the external control device
58 second data string

1. A data acquisition system, the data acquisition system comprising:
at least one sensor device comprising a detection unit, at least one sensor communication interface and a sensor control unit, wherein the sensor device is configured to acquire first object data via the detection unit; and
at least one Universal Serial Bus-Human Interface Device adapter device that is configured to provide a communication connection between the sensor device and an external control device, wherein the USB-HID adapter device comprises a first adapter communication interface, a second adapter communication interface and an adapter control unit,
wherein the sensor control unit is configured to obtain configuration information, to generate a control command based on the configuration information and to transmit the first object data and the control command via the at least one sensor communication interface to the USB-HID adapter device, and
wherein the adapter control unit is configured to obtain the first object data and the control command via the first adapter communication interface, to convert the first object data into second object data different from the first object data based on the control command, and to transmit at least the second object data to the external control device via the second adapter communication interface.

2. The data acquisition system according to claim 1,
wherein the control command specifies a keyboard layout of the external control device.

3. The data acquisition system according to claim 2,
wherein the second object data from the USB-HID adapter device are adapted to the keyboard layout of the external control device.

4. The data acquisition system according to claim 1,
wherein the sensor control unit is configured to obtain the configuration information from the external control device via the at least one sensor communication interface.

5. The data acquisition system according to claim 1,
wherein the sensor control unit is configured to obtain the configuration information by scanning a barcode using the detection unit.

6. The data acquisition system according to claim 1,
wherein the sensor control unit is configured to obtain the configuration information by acquiring user-specific information using the detection unit.

7. The data acquisition system according to claim 1,
wherein the sensor device comprises a first sensor communication interface and a second sensor communication interface that differ from one another.

8. The data acquisition system according to claim 1,
wherein the at least one sensor communication interface, and/or the second adapter communication interface comprises/comprise a USB port.

9. The data acquisition system according to claim 1,
wherein the at least one sensor communication interface, and/or the first adapter communication interface comprises/comprise an Ethernet port.

10. The data acquisition system according to claim 1,
wherein the sensor control unit is configured to transmit the first object data and the control command in a first data string,
wherein the adapter control unit is configured to filter out the control command from the first data string.

11. The data acquisition system according to claim 10,
wherein the adapter control unit is configured to remove the control command from the first data string and to replace the first object data with the second object data in the first data string in order to generate a second data string, and to transmit the second data string to the external control device via the second adapter communication interface.

12. The data acquisition system according to claim 1,
wherein the first and/or second object data comprise barcode information and/or image information of an object to be classified.

13. A USB-HID adapter device for a data acquisition system, the USB-HID adapter device comprising a first adapter communication interface, a second adapter communication interface and an adapter control unit,
wherein the USB-HID adapter device is configured to provide a communication connection between a sensor device for acquiring first object data and an external control device,
wherein the adapter control unit is configured to obtain the first object data and a control command from the sensor device via the first adapter communication interface, to convert the first object data into modified second object data based on the control command, and to transmit at least the second object data to the external control device via the second adapter communication interface.

14. A sensor device for a data acquisition system, the sensor device comprising a detection unit, at least one sensor communication interface and a sensor control unit,
wherein the sensor device is configured to acquire first object data via the detection unit,
wherein the sensor control unit is configured to obtain configuration information, to generate a control command based on the configuration information and to transmit the first object data and the control command via the at least one sensor communication interface to a USB-HID adapter device that is configured to provide a communication connection between the sensor device and the external control device.

15. A method for acquiring object data using a data acquisition system,
wherein the data acquisition system comprises:
at least one sensor device comprising a detection unit, at least one sensor communication interface and a sensor control unit, wherein the sensor device is configured to acquire first object data via the detection unit; and
at least one Universal Serial Bus-Human Interface Device adapter device that is configured to provide a communication connection between the sensor device and an external control device, wherein the USB-HID adapter device comprises a first adapter communication interface, a second adapter communication interface and an adapter control unit,
wherein the method comprises:
obtaining configuration information by means of the sensor control unit;
generating a control command based on the configuration information by means of the sensor control unit;
transmitting, by means of the sensor control unit, the first object data and the control command via the at least one sensor communication interface to the USB-HID adapter device;
obtaining, by means of the adapter control unit, the first object data and the control command via the first adapter communication interface;
converting, by means of the adapter control unit, the first object data into modified second object data based on the control command; and
transmitting, by means of the adapter control unit, at least the second object data to the external control device via the second adapter communication interface.

16. The data acquisition system according to claim 1, wherein the data acquisition system is configured for classifying objects.

17. The data acquisition system according to claim 1,
wherein the detection unit is an optical detection unit.

18. The data acquisition system according to claim 2,
wherein the keyboard layout is specific to a geographical region.

19. The data acquisition system according to claim 4,
wherein the sensor control unit is configured to obtain the configuration information from the external control device via the at least one sensor communication interface in response to a selection of the keyboard layout by a user in a web user interface.

20. The data acquisition system according to claim 5,
wherein the barcode is arranged on an object to be classified.

21. The data acquisition system according to claim 6,
wherein the acquisition of the user-specific information comprises scanning an identification card of the user.

22. The data acquisition system according to claim 7,
wherein the first sensor communication interface and the second sensor communication interface differ from one another with respect to their connection type and/or their type of data transmission.

23. The data acquisition system according to claim 8,
wherein the first sensor communication interface comprises a USB port.

24. The data acquisition system according to claim 9,
wherein the second sensor communication interface comprises an Ethernet port.

25. The USB-HID adapter device according to claim 13, wherein the data acquisition system comprises at least one sensor device comprising a detection unit, at least one sensor communication interface and a sensor control unit, wherein the sensor device is configured to acquire first object data via the detection unit; and
at least one Universal Serial Bus-Human Interface Device adapter device that is configured to provide a communication connection between the sensor device and an external control device, wherein the USB-HID adapter device comprises a first adapter communication interface, a second adapter communication interface and an adapter control unit,
wherein the sensor control unit is configured to obtain configuration information, to generate a control command based on the configuration information and to transmit the first object data and the control command via the at least one sensor communication interface to the USB-HID adapter device, and
wherein the adapter control unit is configured to obtain the first object data and the control command via the first adapter communication interface, to convert the first object data into second object data different from the first object data based on the control command, and to transmit at least the second object data to the external control device via the second adapter communication interface.

26. The sensor device according to claim 14, wherein the data acquisition system comprises at least one sensor device comprising a detection unit, at least one sensor communication interface and a sensor control unit, wherein the sensor device is configured to acquire first object data via the detection unit; and
at least one Universal Serial Bus-Human Interface Device adapter device that is configured to provide a communication connection between the sensor device and an external control device, wherein the USB-HID adapter device comprises a first adapter communication interface, a second adapter communication interface and an adapter control unit,
wherein the sensor control unit is configured to obtain configuration information, to generate a control command based on the configuration information and to transmit the first object data and the control command via the at least one sensor communication interface to the USB-HID adapter device, and
wherein the adapter control unit is configured to obtain the first object data and the control command via the first adapter communication interface, to convert the first object data into second object data different from the first object data based on the control command, and to transmit at least the second object data to the external control device via the second adapter communication interface.

27. The method for acquiring object data according to claim 15, wherein the data acquisition system comprises at least one sensor device comprising a detection unit, at least one sensor communication interface and a sensor control unit, wherein the sensor device is configured to acquire first object data via the detection unit; and
at least one Universal Serial Bus-Human Interface Device adapter device that is configured to provide a communication connection between the sensor device and an external control device, wherein the USB-HID adapter device comprises a first adapter communication interface, a second adapter communication interface and an adapter control unit,
wherein the sensor control unit is configured to obtain configuration information, to generate a control command based on the configuration information and to transmit the first object data and the control command via the at least one sensor communication interface to the USB-HID adapter device, and
wherein the adapter control unit is configured to obtain the first object data and the control command via the first adapter communication interface, to convert the first object data into second object data different from the first object data based on the control command, and to transmit at least the second object data to the external control device via the second adapter communication interface.
